(19) United States
(12) Patent Application Publication
(10) Pub. No.: US 2010/0042691 A1
(43) Pub. Date: Feb. 18, 2010

(54) INTELLIGENT MESSAGE RECEIVING METHOD AND APPARATUS

(75) Inventor: Michael Andrew Maguire, London (GB)

Correspondence Address: NYEMASTER, GOODE, WEST, HANSELL & O'BRIEN, P.C., 700 Walnut Street, Suite 1600, Des Moines, IA, 50309-3899, US

(73) Assignee: BLUE WHALE SYSTEMS LIMITED, London (GB)

(21) Appl. No.: 12/440,264

(22) PCT Filed: Sep. 6, 2007
(86) PCT No.: PCT/GB07/03347

§ 371 Date: May 27, 2009

(30) Foreign Application Priority Data
Sep. 8, 2006 (GB) 0617732.3

(51) Int. Cl. G06F 15/16

(52) U.S. Cl. 709/206

(57) ABSTRACT

The present invention relates to the field of mobile communications and in particular to messaging methods and systems using mobile communications terminals. In particular, but not exclusively, the invention relates to email messaging and in accordance with the invention there is established a connection between at least one mobile communication terminal and a server for a specific period of time which allows messages to be communicated to the terminal. The duration of the connection is typically such as to allow more than one message to be received in any specific time period. The connection time periods are interspersed with periods of non connection and the duration and frequency of said connection time periods may be controlled with respect user selected modes of operation and/or an operating parameter of the mobile communication terminal.

### FIELD OF THE INVENTION

The present invention relates to the field of mobile communications and in particular to messaging methods and systems using mobile communications terminals. In particular, but not exclusively, the invention relates to email messaging.

### BACKGROUND OF THE INVENTION

In recent years, the popularity of and demand for mobile email messaging services have increased. In particular, mobile communications terminals and systems allowing the user to send and receive email messages from a large range of locations are in great demand.

Mobile communications terminals typically send email messages to and receive message from an associated email server via a network, for example a cellular radio network. This allows the user to use the service in any location that allows communication between the terminal and the network. Typically, several terminals will use the same server.

Issues relating to the appeal and success of such mobile communications terminals include the efficient management of the terminal's resources and the time lag between a message arriving at the associated server and the message arriving at the terminal. It is desirable for the terminal to be capable of providing the user with a sense that he or she receives messages immediately after they are sent, whilst also being capable of managing resources efficiently so that the receiving of messages does not place too large a burden on the resources of the terminal. The nature and disadvantages of existing methods by which mobile terminals have been employed to receive messages from a server will be described in the following sections with reference to the accompanying Figures.

A procedure in which a terminal establishes a connection with a server and queries the server to determine whether any new messages are present is commonly referred to as “polling”; this term will be used in the following discussion to indicate such a procedure

One method may be described as a “poll and disconnect” method. In this method, the terminal contacts the associated server and queries it to determine if any new messages have arrived at the server since the last contact. The basic procedure is represented in FIG. 2a, which shows steps taken by the terminal. The terminal first establishes a connection with the server at step S200 and sends an enquiry using this connection to the server to determine if any new messages are present at step S202. If there are no new messages, the terminal disconnects at step S206. However, if at least one new message is present, the terminal will receive data, step S204, associated with the new message or messages. The data will often comprise the complete message, but in some cases, for example if the size of the message is too large to be stored in the terminal's memory, it may comprise, for example, only the subject of the message, or the first few lines of the message. After receiving data, the terminal immediately goes to step S206 and disconnects.

If more than one new message is present at the server, step S204 may comprise a sequence of steps of receiving data associated with each message in turn.

It will be noted that the “poll and disconnect” method enables messages to be received at the terminal only at each poll. No connections are maintained between polls, and consequently no messages can be received between polls. There is therefore potentially a large time lag between a message arriving at the server and the message being received by the terminal. This is explained below.

FIG. 2b shows an example of a sequence of time during which a terminal polls an associated server at times t₂₀, t₂₂, t₂₆ and t₂₈. The polling may be initiated manually by the user, or the terminal may be adapted to poll automatically at regular intervals. At each of the polls 208a, 208b and 208c, the server has no new messages for the terminal. In this example, at time t₂₄ a new message 212 for the terminal arrives at the server. The new message remains at the server until the next time the terminal conducts poll 210 to the server at time t₂₆. There is therefore a time lag of T₀ between the server receiving the message and the terminal receiving the message.

This time lag detracts from the degree of satisfaction that the user gains from using the messaging service. It is desirable that an impression of immediate communication is experienced by the user. This enables a series of communications to be passed between users in quick succession making it possible to make hasty arrangements for a social gathering, for example.

U.S. Patent Application US 2006/0059239 A1 relates to a messaging system with improved management of server resources. A message server is polled at intervals, and the length of the intervals is adjusted according to whether or not new messages were present at the server at the previous poll, and/or according to historical user activity. If no messages have been received, the intervals are increased in order to save resources. However, the problem addressed is efficient management of server resources; the issue of management of mobile terminal resources is not addressed. The receiving method is a “poll and disconnect” method that does not allow the immediate relaying of messages.

The size of the time lag can be reduced by increasing the frequency at which the terminal polls the server. However, frequent polling typically leads to a large number of polls of the type 208a, 208b and 208c in FIG. 2b which result in no new messages being received by the terminal and therefore expend resources without providing any benefit. Polling places a burden on the resources available to the mobile terminal; in particular, the life of the terminal's battery is shortened by excessively frequent polling. It will be appreciated that a short battery life, necessitating frequent recharging, is undesirable. Furthermore, becoming unable to use the terminal to perform any functions of the terminal, including messaging functions and other functions, due to lack of power can cause considerable inconvenience to the user.

Another method of receiving messages is known as a “push” method. In this method messages arriving at the server or data relating to the messages are relayed to the terminal with a relatively short time lag. An example of a push method is described with reference to FIGS. 3a and 3b. At the start, step S300, of the messaging session, the terminal connects to the server or, in some cases, may instead raise a connection into the wireless network in such a way as to be addressable from the server. The connection is typically initiated by starting a messaging application, or by turning on the terminal. In the example shown, new messages 306, 308 are received at the server at times t₃₂ and t₃₄. Data relating to the messages is then immediately sent at step S302 to the terminal. The session is ended at step S304 typically by turning off the terminal or shutting down the terminal. The terminal remains connected to the server (or remains connected into the network in such a way as to be addressable from the server) for the entire session. However, maintaining a constant connection consumes resources of the terminal, in particular battery power. Much of this consumption is wasteful, as it results in no data being transferred to the terminal, and is therefore of no benefit to the user.

Other methods of implementing push messaging may involve, for example, the server immediately notifying a terminal of the arrival of a new message, by means of an out of band notification such as SMS, in response to which the terminal is prompted to poll the server to receive the new message. However, systems using SMS messages to notify the terminal of the arrival of a new message are limited because many messaging servers are not configured to send SMS messages. Moreover, even where available, use of out of band mechanisms such as SMS involves considerable extra expense.

Note that the “poll and disconnect” method described above might also be categorised as a push method if the frequency of polling is sufficiently high. This method suffers from the problems described above.

The above push methods provide the user with a sense of immediacy by maintaining constant connections, by the use of out of band notification mechanisms, or by polling and disconnecting with the server at relatively high frequency. Some existing mobile terminals which use constant connections are proprietary devices that are designed from the hardware up to support this type of operation. However, it is often impractical for such messaging methods to be used on general purpose mobile devices, due to the problems described.

International Patent Application WO 2005/029297 relates to a method of operating an electronic device to perform email functions in a low power mode. Components of the device that are not necessary for email are deactivated in the low power mode. However, the method of receiving messages used is a polling method and no method of managing the normal power email operation of the device efficiently is disclosed.

It is often the case that the user will have access to devices other than a mobile terminal that are capable of receiving the same messages, such as a desktop computer. These devices may employ more instantaneous ways of receiving messages, resulting in messages arriving at the mobile terminal consistently later than at the computer. It would be desirable to allow a mobile terminal to receive messages quickly whilst conserving battery power.

It is an object of the present invention to provide a method of receiving messages that at least mitigates the problems of the prior art.

### SUMMARY OF THE INVENTION

In accordance with one aspect of the present invention, there is provided a method of receiving messages in a data communications network using a mobile communications terminal, said network comprising a server, said server being capable of receiving new messages, and in response to receiving said new messages, of making data relating to said new messages available for transmission to an associated mobile communications terminal,

said method comprising performing functions which said mobile communications terminal is adapted to perform, the performance of said functions comprising:

performing message receiving procedures, wherein during a message receiving procedure said mobile communications terminal is capable of receiving data relating to new messages for said mobile communications terminal received by said server since a previous message receiving procedure;

intermittently establishing connections in the network such that the terminal establishes a series of connections;

maintaining said connections for extended time intervals, wherein the mobile communications terminal is capable of performing a first said message receiving procedure over a connection after establishment of the connection and wherein the connection is extended beyond said first message receiving procedure such that, if the server receives a new message for said mobile communications terminal after said first message receiving procedure and during said extended time interval, the mobile communications terminal is capable of receiving said new message over said connection; and

terminating said connections in response to said extended time intervals elapsing, such that said series of connections are interspersed with periods during which said connections are not maintained.

Thus, the present invention provides a method of receiving messages that intersperses connected intervals, enabling immediate, or substantially immediate, relaying of messages or data related to messages, with disconnected periods during which the terminal does not have a connection with a network, and thus does not expend resources. A method that allows both a sense of immediate receipt of messages after sending and efficient resource management is thus provided.

Embodiments of the present invention have features that avoid excessive and/or wasteful use of resources and improve the messaging experience for the user.

In some embodiments, said connections comprise connections to said server. The connections may comprise connections arranged such that said mobile communications terminal is notified by the server in response to a new message arriving at the server. These features enable connections to be established directly between a mobile terminal and a server, enabling messages and/or data related to messages to be transmitted over the connections. In some embodiments the connections involve data transmissions using an IMAP protocol and said connections comprise periods during which an “IMAP Idle” state is entered.

The performance of said functions may alternatively comprise conducting a plurality of polls to said server during a said connection. This feature enables the invention to be implemented without using “IMAP idle”.

The performance of said functions may comprise polling the server immediately after a connection is established. This allows the terminal to poll the server, and maintain a connection for an extended interval after polling, making efficient use of resources.

In preferred embodiments, the performance of said functions comprises altering a time characteristic of at least one of said extended time intervals and said periods. This allows the connections to be managed to use the terminal resources efficiently. The altering may comprise altering the ratio of a length of at least one of said extended time intervals relative to a length of at least one of said periods. This allows control of the proportion of time during which the connection is maintained. The altering may comprise altering said length of at least one of said extended time intervals. Alternatively, or additionally, the altering may comprise altering said length of at least one of said periods. Thus the amount of time spent connected and the amount of time spent not connected may be altered according to power control considerations.

In some preferred embodiments, said mobile communications terminal comprises an electric power source, and said altering is conducted in response to a power level of the power source. This feature enables the connections that the mobile communications terminal establishes to be managed to effectively take account of the power available to the terminal. For example, in a battery operated terminal, the proportion of time during which a connection is maintained may be reduced when battery power is low, thus increasing the usable life of the battery.

In some preferred embodiments, the performance of said functions comprises:

monitoring a power level of said power source;

operating in a low-power mode if said power level is below a predefined level; and

operating in a high-power mode if said power level is above a predefined level;

and wherein said altering comprises altering said time characteristic according to whether the mobile communications device is operating in said low-power mode or in said high-power mode.

This feature provides a way of managing the connections so that, for example, the connections may be maintained for longer when the terminal is operating in a high power mode than when it is operating in a low power mode.

In some preferred embodiments, said mobile communications terminal is adapted to operate in a plurality of user-selectable states, and said altering comprises altering said time characteristic according to the state selected. This feature allows, for example, the mode of operation the user selects to influence the proportion of time that the terminal maintains a connection. If a user selects a “meeting mode” or “silent mode”, for example, this may suggest that the user does not want to be interrupted by frequent messages arriving at his or her terminal; the proportion of time spent with the terminal connected may therefore be reduced accordingly, saving the resources of the terminal.

In some preferred embodiments, said altering comprises altering said time characteristic according to the time of day. Additionally, or alternatively, said altering comprises altering said time characteristic according to the day of the week. It may be less important to receive message updates at certain times, such as late at night, or during weekends. Reducing the proportion of time that the terminal maintains connections during these times prevents unnecessary consumption of resources.

In preferred embodiments, said mobile communications terminal is adapted to:

operate in a home mode when said network comprises a home network; and

operate in a roaming mode when said network comprises a roaming network, and

wherein said altering comprises altering said time characteristic according to whether the mobile communications terminal is operating in said roaming mode or in said home mode.

This feature enables costs to be reduced when using the mobile communications terminal in conjunction with a network other than the network with which it is registered (i.e. in a roaming network rather than a home network). It is a well known characteristic of mobile communications services that the costs of using the service in a roaming network (for example, when in a foreign country) are high compared to the costs in a home network. The present feature enables the proportion of time spent connected when in a roaming network to be reduced compared to that of a home network, lowering costs.

The method may comprise storing user behaviour data, wherein said altering comprises altering said time characteristic according to said user behaviour data. The particular habits of the individual user may for example, lead to frequent receiving of messages at particular times of the day or week. This feature enables such behaviour to affect the behaviour of the mobile terminal so that, for example, the proportion of time spent connected is increased at times when many messages tend to be received, allowing messages to be received substantially immediately after they are sent and improving the messaging experience of the user.

In some arrangements, the performance of said functions can comprise establishing an unscheduled connection to the server in response to a user action, said establishing an unscheduled connection occurring during a given said period. In some embodiments, the performance of said functions comprises maintaining said unscheduled connection for a said extended time interval. The user action may comprise initiating the sending of a message. Hence, if the user initiates the sending of a message, for example, a connection may be immediately established to enable the sending. The connection thus established may then be maintained for an extended time interval; this allows, for example, a quick response to the sent message to be received immediately, without having to wait for the following connection.

In accordance with a second aspect of the second invention, there is provided a method of receiving messages in a data communications network using a mobile communications terminal, said mobile communications terminal comprising an electric power source, said network comprising a server, and said method comprising performing functions which said mobile communications terminal is adapted to perform, the performance of said functions comprising:

intermittently establishing connections to the server;

determining if any new messages are present at the server; and

altering a time characteristic of said intermittently established connections in order to reduce power usage for said electric power source.

This aspect of the invention provides a way of receiving messages via connections, the timings of which are dynamically varied to improve, for example, the battery life of the terminal being used. In some arrangements, said altering comprises altering a length of time during which said connections are maintained.

Advantageously, said altering may be conducted responsive to a power level of the power source. Timings of connections can thus be managed to be responsive to the power available to the terminal allowing, for example, frequent connections when there is a high power level.

Preferably, the performance of said functions comprises:

monitoring a power level of said electric power source;

operating in a low-power mode if said power level is below a predefined level; and

operating in a high-power mode if said power level is above said predefined level, and

wherein said altering comprises altering the time characteristic according to whether the mobile communications terminal is operating in a low-power mode or operating in a high-power mode.

This feature enables the connections that the mobile communications terminal establishes to be managed to effectively take account of the power available to the terminal. For example, in a battery operated terminal, the length of time between connections may be increased when battery power is low, thus increasing the usable life of the battery.

In some arrangements, the performance of said functions comprises operating in any of a plurality of user-selectable states, and said altering comprises altering the time characteristic according to the state selected. Hence, the timing of connections, for example, may be altered to reduce power consumption if the user selects, for example, a silent mode.

In some embodiments, said altering can comprise altering the time characteristic according to a time of day. Alternatively, or additionally, said altering can comprise altering the time characteristic according to a day of the week. Hence, the method allows, for example, more frequent connections to be established during times when many messages are received.

In some embodiments, the performance of said functions comprises:

operating in a home mode when said network comprises a home network; and

operating in a roaming mode when said network comprises a roaming network,

wherein the altering comprises altering the time characteristic according to whether the mobile communications device is operating in said roaming mode or in said home mode. Connections may be established more frequently in home networks, where costs may be lower.

The method may comprise storing user behaviour data and wherein said altering comprises altering the time characteristic according to said user behaviour data. Thus, data relating to, for example, when the user tends to receive few messages can be stored, and the number of connections occurring at those times may be reduced.

In accordance with a third aspect of the present invention, there is provided a computer program arranged to adapt a mobile communications terminal to conduct the method steps described above.

In accordance with a fourth aspect of the present invention, there is provided a mobile communications terminal adapted to conduct the method steps described above.

In accordance with a fifth aspect of the present invention, there is provided a system comprising means to implement a method as claimed in any preceding claim, said system comprising a mobile communications network and plurality of mobile communications terminals, each said terminal being adapted to perform functions as described above.

Preferably, said mobile communications terminals are arranged such that said extended time intervals on a given said terminal tend not to coincide with respective said extended time intervals on another said terminal. Thus, the times during which terminals are connected to a network can be arranged to be staggered with respect to one another, avoiding congestion of the network.

Conveniently, the plurality of mobile communications terminals can be grouped so that said extended time intervals of a given group tend not to coincide with said extended time intervals of another group. In one embodiment, said terminals comprise scheduling means for scheduling timings of said extended time intervals according to schedules triggered by internal clocks on the terminals. This provides a convenient way of arranging so that the timings of connections tend not to coincide.

Preferably, terminals comprise connecting means for performing unscheduled connections, wherein said scheduling means are capable of controlling subsequent connections such that schedules are returned to after the occurrence of an unscheduled connection. Hence, even when unscheduled connections are made due to, for example, sending a message, the schedules can be subsequently maintained in order that a pattern similar to the original pattern of staggered connecting is maintained.

Further features and advantages of the invention will become apparent from the following description of preferred embodiments of the invention, given by way of example only, which is made with reference to the accompanying drawings.

In a further aspect of the invention there is provided a method of receiving messages in a data communications network using a mobile communications terminal, said network comprising a server capable of receiving new messages, and in response to receiving said new messages, of making data relating to said new messages available for transmission to an associated mobile communications terminal, said method comprising controlling the connection between the server and the mobile communications terminal to specific time intervals during which messages can be received by the terminal from the server and wherein the duration of said specific time intervals and/or the frequency of connection is controlled via the mobile communications terminal in response to a user selected operating mode of the terminal and/or at least one parameter of the operating condition of the mobile communications terminal at that time.

In one embodiment the user selected operating mode is selected by the user in response to a particular environment in which the terminal is positioned.

In one embodiment the operating condition parameter of the mobile communication terminal is the available power source and/or level of power available at that time.

In one embodiment if a predetermined number of messages are received within a specific connection time period, the terminal may extend that time period of connection.

In one embodiment if a message is received at/or near the end of a specific connection time period, the terminal may extend that time period of connection.

### BRIEF DESCRIPTION OF THE DRAWINGS

FIG. 1a shows a plurality of mobile communications terminals, a network, a server and connections between them;

FIG. 2a is flow diagram showing steps involved in performing a poll of a server;

FIG. 2b is a timeline showing a polling method of receiving messages from a server;

FIG. 3a is a flow diagram showing a push method of receiving messages;

FIG. 3b is a timeline showing a push method of receiving messages;

FIG. 4a is a timeline showing intermittent connections established in a network by a mobile terminal according to embodiments of the present invention;

FIG. 4b is a time line of a server receiving and transmitting messages according to embodiments of the present invention;

FIG. 5a is a flow diagram showing steps involved in using IMAP to receive messages from a server;

FIG. 5b is a schematic timing diagram showing an example IMAP session in which a terminal receives message data from a server;

FIG. 6a is a flow diagram of a mobile communications terminal polling a server using an extended connection with the server;

FIG. 6b is a schematic timing diagram of an example polling session in which a mobile terminal establishes a connection with a server and repeatedly polls the server using the connection;

FIG. 6c is a timeline of a mobile terminal repeatedly polling a server and the server transmitting new messages to the terminal;

FIG. 7a is a timeline of time intervals during which connections are maintained interspersed with periods during which connections are not maintained;

FIG. 7b is a timeline showing the occurrence of a change in the length of the connected intervals due to a change in a parameter of the mobile communications terminal;

FIG. 7c is a timeline showing the occurrence of a change in the length of the disconnected periods due to a change in a parameter of the mobile communications terminal;

FIG. 8a is a timeline showing a sequence of time intervals in which connections are maintained and periods in which connections are not maintained;

FIG. 8b is a timeline showing a first example of the sequence being interrupted by the sending of a message;

FIG. 8c is a timeline showing a second example of the sequence being interrupted by the sending of a mobile communications terminal;

FIG. 9 is a timeline showing a change in the frequency at which a mobile communications terminal polls a server;

FIG. 10 is a schematic timing diagram showing mutually non-coinciding connections made by three terminals in a common network.

### DETAILED DESCRIPTION OF THE INVENTION

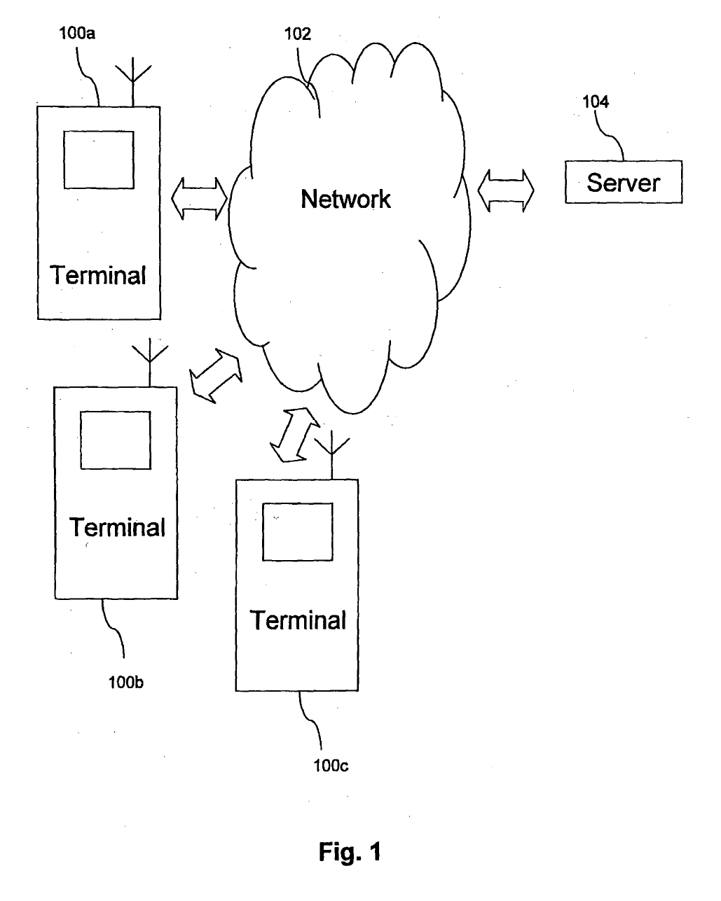

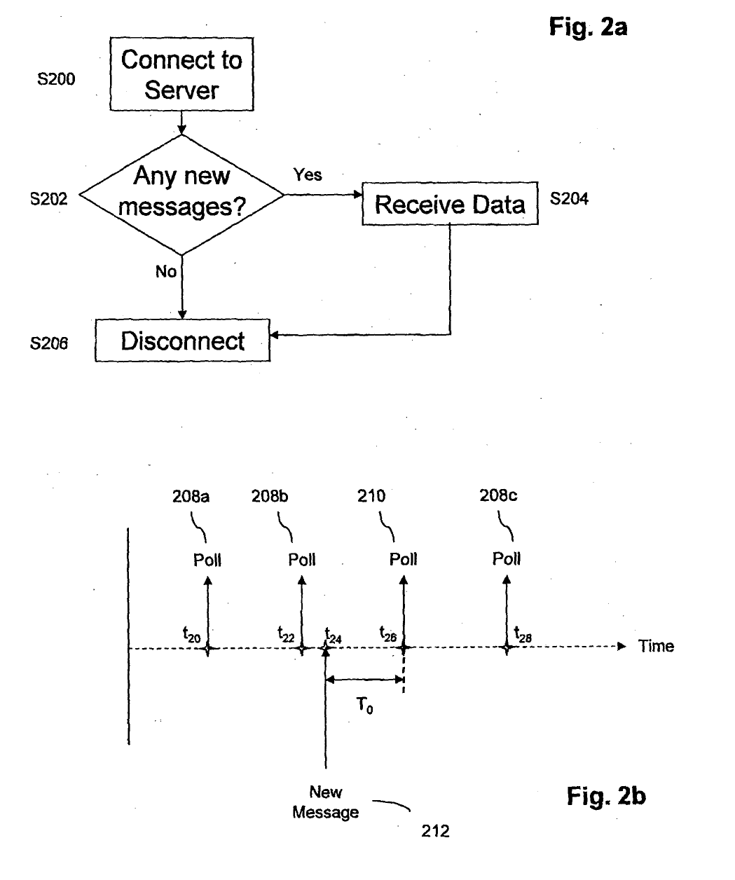

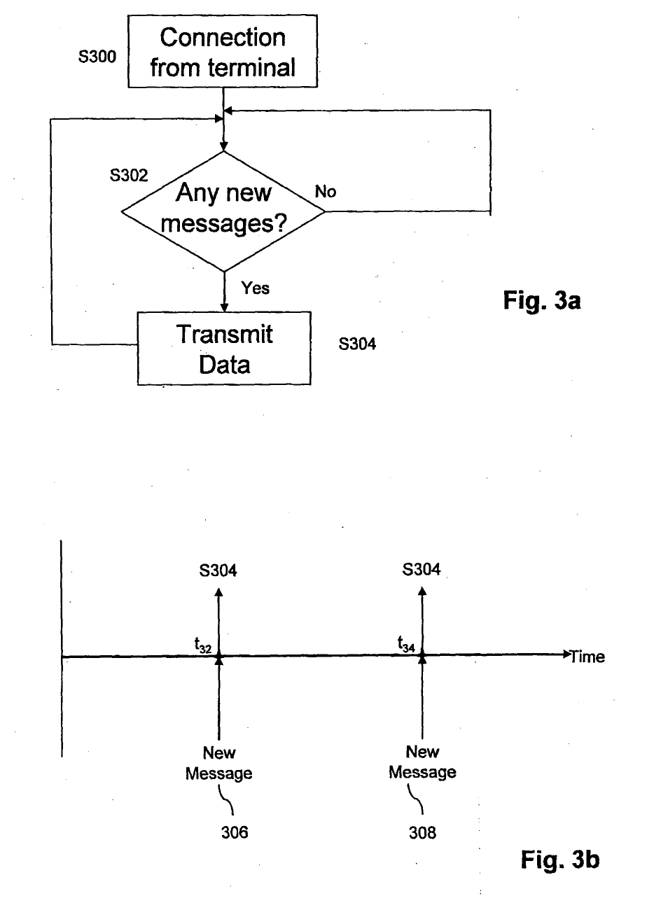

Embodiments of the present invention relate to a method of receiving messages to a mobile communications terminal from a server in a network. FIG. 1 is a representations of a system within which embodiments of the present invention may be realised. In such systems, messages are sent between mobile terminals 100a, 100b, 100c, and other messaging devices, such as computers, via a server 104. Typically, each mobile terminal has an associated server and an inbox at the server with an assigned address for receiving messages. A message sent from a first terminal contains one or more destination addresses for the message, and the message is routed to the inbox or inboxes specified by the address or addresses. The message then remains in the inbox until the corresponding mobile terminal accesses the inbox and retrieves the message.

The network may be a GSM network. Communication between the mobile communications terminal and the network, and between the network and the server, is typically implemented wirelessly using standards such as GPRS and using a connection-based packet mode protocol, such as TCP.

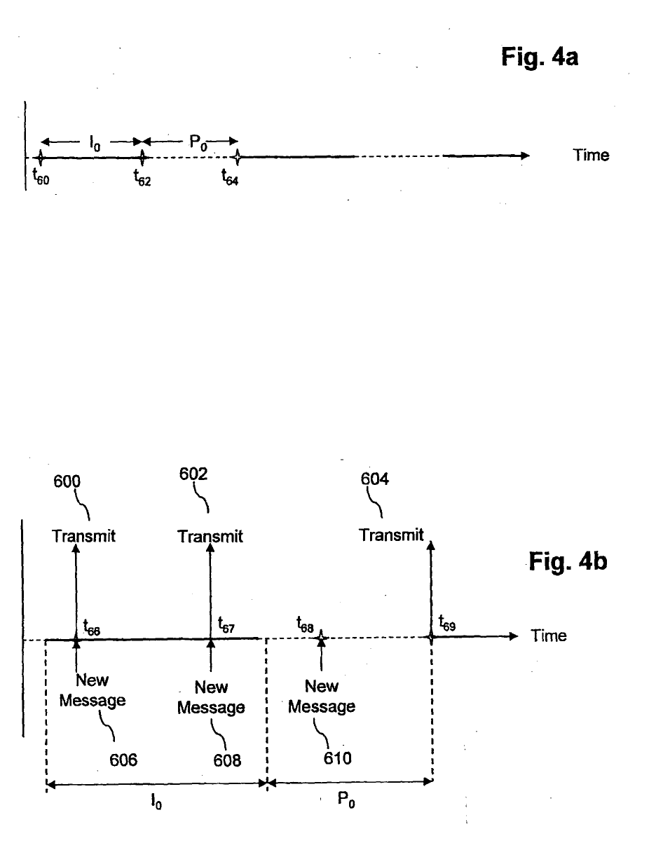

Turning to FIG. 4a, in embodiments of the present invention, a mobile communications terminal forms a series of connections in a network such that extended time intervals during which connections are established and maintained are interspersed with periods of time during which connections are not maintained. In the following discussion, time intervals during which the terminal does not maintain connections for receiving messages will be referred to as “disconnected periods”, and time intervals during which the terminal does maintain connections for receiving messages will be referred to as “connected intervals”. In this Figure and other Figures, solid lines represent connected intervals and dashed lines represent disconnected periods. A connection is established at time t₆₀. The connection allows data to be transmitted between a server and the terminal. In particular, the connection allows the transmission of messages and/or data related to messages. Typically, the messages are email messages sent between two or more users, though other types of message are possible. In the following discussion and examples, for conciseness we will refer to the transmission of messages, but the skilled reader will understand that the present invention may equally well be applied to, for example, parts of messages, data relating to messages, notifications of the arrival of messages etc.

The connection established at time t₆₀ is maintained by the terminal for an extended connected interval of length I₀, until time t₆₂. During the time interval Iₒ, messages can be transmitted from the server to the terminal. At time t₆₂, however, the terminal terminates the connection and does not establish another connection for a disconnected period of length P₀, during which no transmission of messages from the server to the terminal takes place. The disconnected period P₀ elapses at time t₆₄, and a connection is again established between the terminal and the server. Thus, connected intervals during which message receiving via a connection is enabled are interspersed with disconnected periods in which there is no such connection.

FIG. 4b shows the timings of three messages arriving at a server and being transmitted to an associated terminal. The first two messages, 606, 608, arrive at the server during a connected interval when the terminal is maintaining a connection with the network. The first message, 606, arrives at the server at time t₆₆, and a message receiving procedure is implemented to enable the terminal to receive message 606 from the server immediately (or with negligible time gap) after arrival. The second message, 608, arrives at time t₆₇, at which the same connection used to receive message 606 is still being maintained. The connection is used again to receive the second message. The third message, 610, arrives at a time t₆₈ when there is no connection between the terminal and the server. Message 610 is therefore stored at the server, until the next connection is established at time t₆₉. In preferred embodiments, a typical length of a connected interval, I₀, is approximately 5 minutes, and a typical length of a disconnected period, P₀, is approximately 4 minutes.

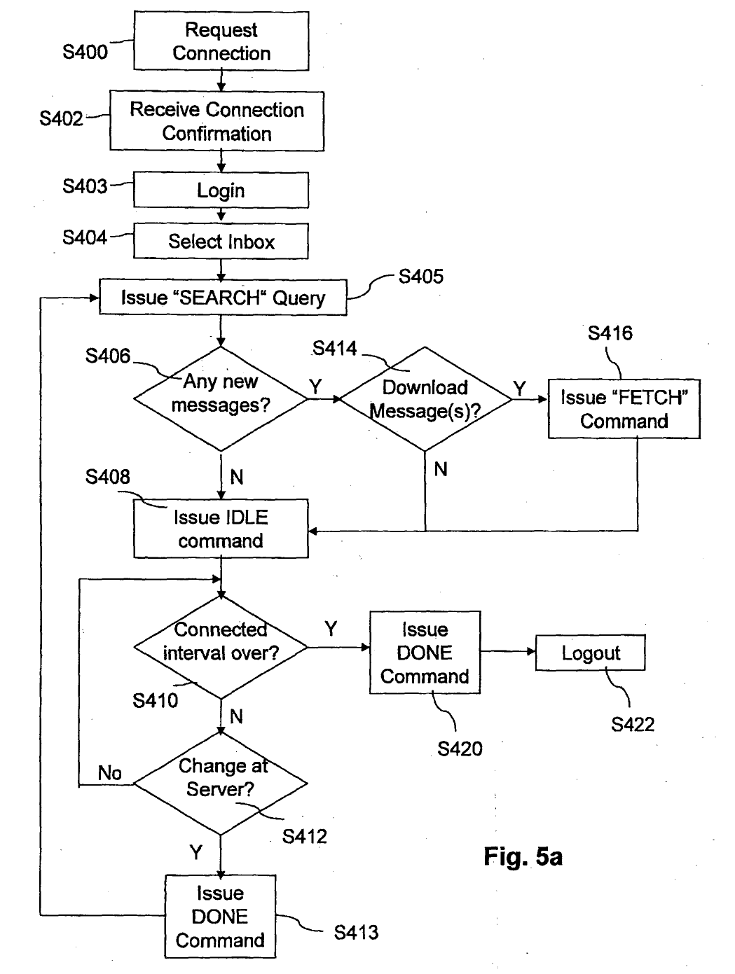

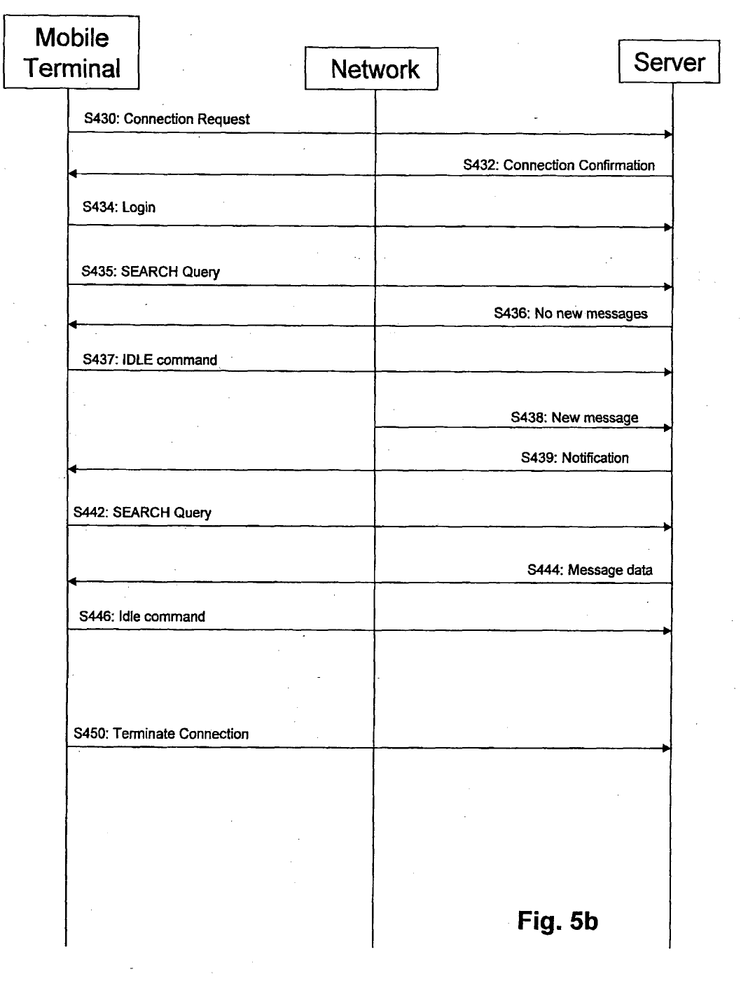

In some arrangements, the terminal forms a connection with the server using an IMAP protocol, for example IMAP4 Rev. 1, and the connection maintained using the IMAP IDLE command. The reader is directed to IETF:RFC:3501 for information on the IMAP4 Rev. 1 specification, and to IETF:RFC:2177 for information on the IMAP IDLE command specification. IMAP can be used to implement message receiving procedures as described above. A detailed example of this will now be given with reference to FIG. 5a.

The terminal first transmits a connection request at step S400 to the corresponding server, using the IP address of the server as the destination for the transmission. The server responds with a connection confirmation which is received by the terminal at step S402. The terminal then logs in at step S403 using a password. This establishes a connection between the terminal and the server over which the terminal can perform various operations such as managing or creating folders. In order to issue queries about individual messages, a specific folder is selected. In this example, the terminal selects the inbox at step S404. In order to view the contents of the inbox, the terminal issues a “SEARCH” query at step S405. The server then issues information regarding the state of the inbox, including the presence of messages. The terminal ascertains if there are any new messages at step S406. If there are, the terminal must then determine, at step S414, whether or not to download the messages. This determination may be based on factors such as the size of the message (if known) and how much memory space the terminal has available for the storing of messages. If the determination is to download, the terminal downloads at least parts of some or all of the new messages, by issuing a FETCH command, at step S416.

After the download is complete, or, in preceding steps, if there are no new messages, or if the terminal determines not to download any messages, the terminal issues an idle command at step S408 to the server. This puts the terminal and server into a state whereby the connection between it and the server is maintained, and the server notifies the terminal of any changes of the state of its inbox.

In preferred embodiments, the terminal records the time at which the connection is established at step S402 and monitors for the elapsing of a connected interval. If the server notifies the terminal of a change at step S412 of the state of the terminal's inbox before the terminal determines that the connected interval for the current session has elapsed, the terminal issues a “done” command at step S413 to complete the idle state. The terminal then returns to step S405, where it checks for any new messages, and can then download any that are present, as described above.

This process continues until the terminal determines that the connected interval has elapsed at step S410 and issues the done command at step S420 and logs out at step S422, terminating the connection between the terminal and the server.

The skilled reader will recognise that the above described procedure comprises an initial polling of the server by the terminal at steps S405, S406, S414 and S416, followed by entry into an idling state at step S408, which enables messages to be received by the server with little or no delay after they arrive at the server. The initial polling allows the terminal to ascertain whether any new messages have arrived at its inbox since the last connection. Both the initial polling and the idling state make use of the same connection.

An example connected interval is now described with reference to FIG. 5b. The mobile terminal initially establishes a connection with the server, via a network, at steps S430 and S432 and logs in at step S434. At step S435 it queries the server to ascertain if any new messages have arrived since the previous connected interval. In this example, no new messages have arrived, so the server transmits data that indicates this at step S436, and the terminal issues the idle command at step S437, and waits for a change in the state of its inbox at the server. Some time later, at step S438, a new message arrives at the server from the network, having been transmitted from another terminal connected to the network. The server notifies the terminal, step S439, of a change in the state of the terminal's inbox. The terminal then sends a SEARCH query, step S442, and downloads message data at step S444. It then issues another idle command, step S446. In this example, no further messages arrive at the terminal, and, at the appropriate time, the terminal terminates its connection with the server, at step S450. For conciseness, some steps used in performing actions such as receiving message data have been omitted from FIG. 5b and the above accompanying explanation. For example, after logging in at step S434, the terminal selects an inbox of the server. Further, in order to download message data at step S444, the terminal issues a FETCH command, as described with reference to FIG. 5a. The skilled reader will recognise that the omitted steps are implicit in the explanation given.

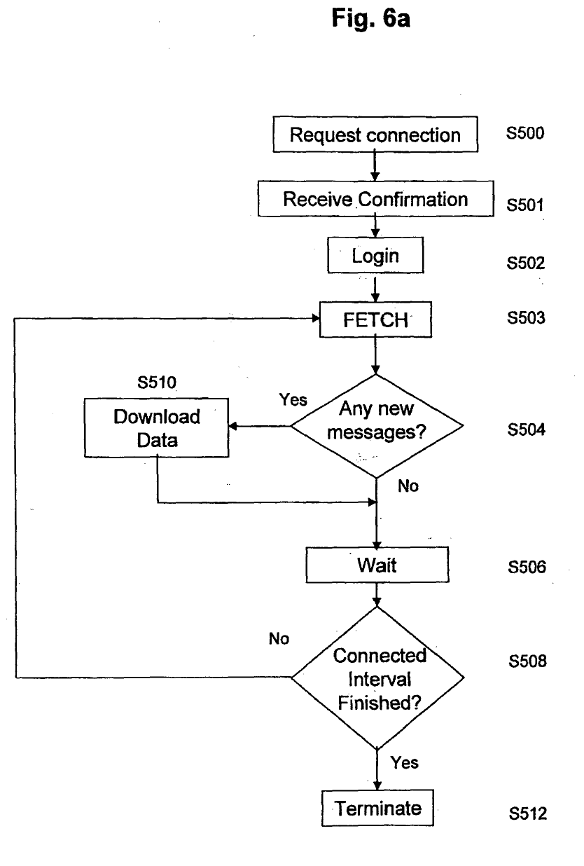

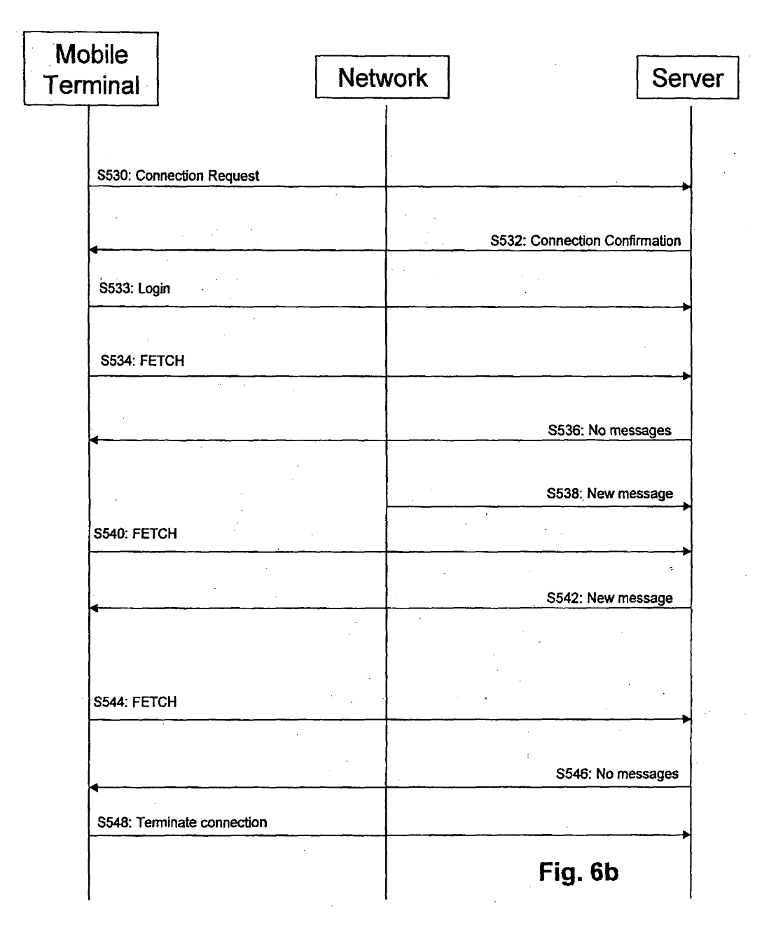

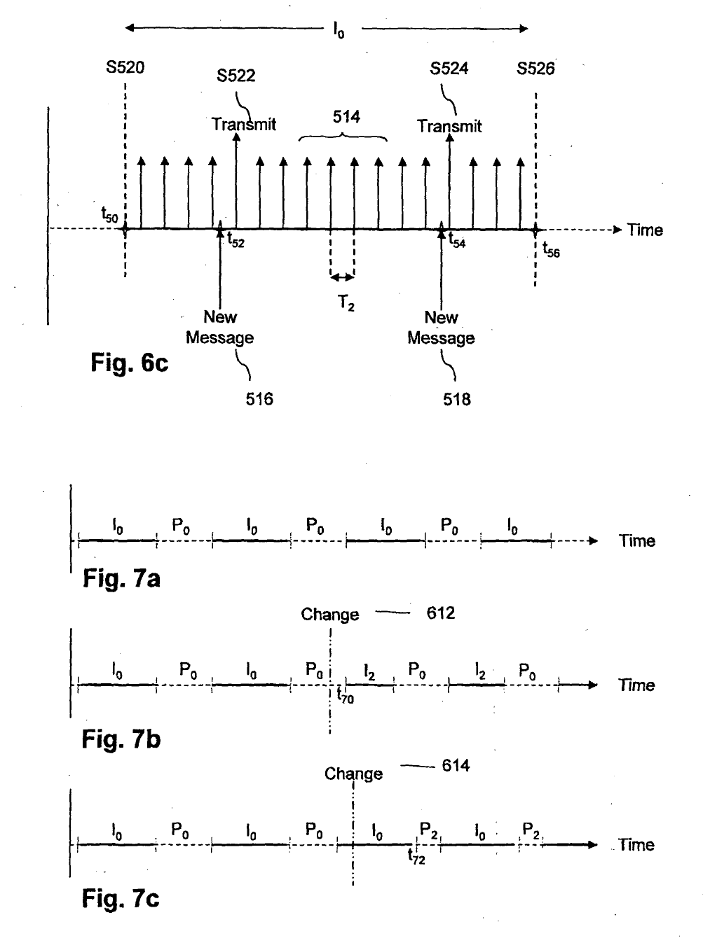

Some servers do not support IMAP IDLE. An example embodiment of the present invention in which a mobile communications terminal receives messages and/or message data from a server without using IMAP IDLE is now described with reference to FIG. 6a, FIG. 6b and FIG. 6c.

FIG. 6a shows an example procedure in which a terminal establishes a connection with a server and uses this connection to repeatedly and frequently issue FETCH commands to the server. The terminal first requests a connection with the node at step S500, receives confirmation of the connection at step S501 and logs in at step S502. The terminal then uses the connection thus established to issue a FETCH command (or an equivalent) to the server at step S503. If there are new messages for the terminal at the server, the terminal downloads data related to some or all of these at step S510, and proceeds to step S506; if there are no new messages for the terminal, it proceeds directly to step S506. At. step S506, the terminal waits for a prescribed time interval before determining at step S508 whether the connected interval has finished. If it has, then the terminal terminates its connection with the mobile at step S512. If the connected interval has not finished, the terminal returns to step S503 and issue another FETCH command. This process continues until the terminal determines at step S508 that the connected interval has finished and terminates the connection at step S512.

It should be noted that the process of establishing a connection with and logging in to the server, represented by step S500 to step S502 in FIG. 6a generally places a considerably greater burden on the resources of the mobile terminal greater resources than issuing the FETCH command. The above described process of establishing a connection and using this connection to issue several FETCH commands therefore makes efficient use of the terminal's resources. Furthermore, since the issuing of the FETCH commands does not place a large burden on terminal resources, the frequency of the issuing can be made relatively high, providing the user with a sense of immediacy in receiving messages.

An example connected interval is now described with reference to FIG. 6b, The terminal first sets up a connection with the server at step S530 and step S532, and logs in at step S533. It then repeatedly issues FETCH commands at step S534, step S540 and step S544. At step S534 and step S544, there are no new messages at the server for the terminal, so the server transmits data to the terminal that indicates that there are no new messages (using the connection established at step S530 to step S532). Between steps S534 and S540, a new message for the terminal arrives at the server from the network. This new message is stored at the server until the terminal issues a FETCH command to the server at step S540. The message, or data relating to it, is then transmitted to the terminal at step S542. At step S548, the terminal terminates its connection with the server. For conciseness, the above example describes a series of only three FETCH commands, but it will be appreciated that, in practice, connected intervals may comprise a greater number of FETCH commands.

FIG. 6c shows another example messaging session. The connected interval begins when a mobile communications terminal establishes a connection, at step S520, with a server at time t₅₀, and continues until the connection is terminated by the terminal, at step 526, at time t₅₆. The connection between the terminal and the server is maintained for the duration of the connected interval. During the connected interval, the terminal repeatedly issues FETCH commands to the terminal using the connection, there being a gap of length T₂ between each command. New messages 516 and 518, or data relating thereto, arriving at the server are thus relayed to the terminal at step S522 and step S524 respectively after only a short delay, of maximum length T₂.

Generally, a greater burden is placed on the power source of the terminal, typically an electric power source in the form of a rechargeable battery, when it is connected to the server or network than when it is not. Furthermore, the burden on the power source of establishing connections and logging in to the server also requires consideration. Effective management of the timing characteristics of establishing and terminating connections to make efficient use of the power source is thus a beneficial feature of embodiments of the present invention.

The timing characteristics to be managed may include the proportion of time that the terminal maintains connections, which is of particular relevance to the expenditure of the power source. This proportion can be controlled or altered by controlling or altering the ratio of the time spent connected to the time spent not connected. This ratio may be controlled or altered by controlling or altering the length of either or both of the length of duration of a single connection and the length of time between consecutive connections. The means for monitoring and determining the timings may be known means, such as an internal clock of the terminal. In preferred embodiments the ratio is between 1:9 and 9:1. In still preferred embodiments, the ratio is between 1:2 and 2:1.

In the following discussion, we will refer to the above described ratio as “the timing ratio”. The discussion will be framed in terms of the timing ratio, but it will be understood by the skilled reader that the invention could equally well apply to other timing characteristics such as, for example, the maximum length of time spent disconnected from the server (which may influence how immediate the user perceives the service to be).

In some embodiments of the present invention, the terminal comprises means for calculating and setting the timing ratio based on parameters, examples of which are given below. The terminal may calculate the timing ratio each time the messaging application is started. Further, in advantageous embodiments, the terminal monitors the parameters, and alters the timing ratio in response to a change in one or more of them.

Possible parameters for calculating and altering the timing ratio include a power level of the power source, a state selected by a user, the time of day, the day of the week, characteristics of the network within which the terminal is currently operating and user behaviour data. These are each explained in more detail below.

Known means can be employed to monitor a power level of the power source, the power level indicating, for example, the power source's capacity to continue to supply power to the terminal. The terminal may be adapted so that, for example, it alters the timing ratio continuously according to some proportional relationship with a value indicative of the power source's power level. Alternatively, or additionally, a predefined level can be set, and the terminal adapted to operate in a high-power mode when the power level is above the predefined level and in a low-power mode when the power level is below the predefined level. Establishing and maintaining connections for communicating messages tends to drain such power sources. Accordingly, in some embodiments of the present invention, the terminal monitors a power level of its power source and alters the timing ratio accordingly. Typically, the proportion of time spent connected in a low power mode will be lower than the proportion in a high power mode.

It is a common feature of mobile communications terminals, such as mobile phones, that the user may select states of the terminal to alter certain features of its operation. These states are commonly referred to as “profiles”. Mobile terminals typically notify the user of the arrival or a new message or telephone call by vibrating and/or playing a pre-defined tune. These notifications can be altered or cancelled by selecting, for example, a “meeting profile”, so that the user is not disturbed during a meeting. An advantageous feature of embodiments of the present invention is that the selection of a profile can affect the timing ratio.

In some arrangements of the present invention, the terminal alters the ratio according to the time of day, or day of the week. These can be monitored using for example an internal clock of the terminal.

Mobile communications terminals are typically capable of operating in a “home” network, with which they are registered and in “roaming” networks within which they are not registered. In some embodiments of the present invention, the mobile terminal is adapted to detect whether it is currently operating in a home network or a roaming network and alter the timing ratio.

In some arrangements, the data relating to user behaviour is stored and the timing ratio altered based on this data. For example, there may be times of the day when user tends to receive many messages compared to other times. Data indicating such times of day may be stored, and the ratio altered so that the proportion of time spent connected is greater during times of increased activity.

The above list of parameters used to alter the timing ratio is non-exhaustive; other parameters may be used without departing from the spirit of the invention.

A description of how a change in one of the above described parameters may affect the timing ratio will now be given. FIG. 7a is a time line showing a series of connected intervals during which the terminal maintains connections for receiving messages alternating with disconnected periods during which no such connections are maintained. In this example, the length of each connected interval is I₀ and the length of each disconnected period is P₀. These lengths may be kept constant unless there is a change in one of the parameters described above. In the case of FIG. 7a, no change takes place and the respective lengths of each disconnected period and each connected interval remain constant at P₀ and I₀ respectively.

FIG. 7b is a time line showing the effect of a change in one of the parameters. In the sequence shown, a change, 612, in one of the parameters occurs during a disconnected period of length P₀. This change may consist of the user selecting a different profile for the terminal, or a transition into a low-power state of the power source, for example. In this example, the disconnected period elapses at time t₇₀ at which point a connection is established. However, while the length of each connected interval before the change is I₀, the length of each connected interval after the change is altered to a shorter length I₂. The length of each disconnected period remains constant at P₀. This alteration reduces the proportion of time that the terminal maintains connections, helping to save terminal resources.

The action of an alternative arrangement is represented in FIG. 7c. In this example, a change, 614, takes place during an connected interval. The change is registered by the terminal, which triggers a transition of P₀ to P₂ in the length of subsequent disconnected periods, P₂ being shorter than P₀. The length of the connected intervals remains unaltered at I₀, both before and after the change. The transition thus increases the proportion of time that the terminal maintains connections, increasing the probability that a new message arriving at the server will do so during a connected interval, and therefore be transmitted immediately to the terminal.

In the above examples, either disconnected periods or connected intervals are adjusted; however, in some arrangements both may be adjusted. This may be done in such a way that the frequency with which the terminal establishes connections remains substantially constant, for example.

Connections are not just required for receiving messages; other activities such as sending messages also require connections. It may be inconvenient for the user if he or she is unable to send any messages due to a lack of connection during an above-described disconnected period, and has to wait until the following scheduled connection before being able to do so. Embodiments of the present invention overcome this problem.

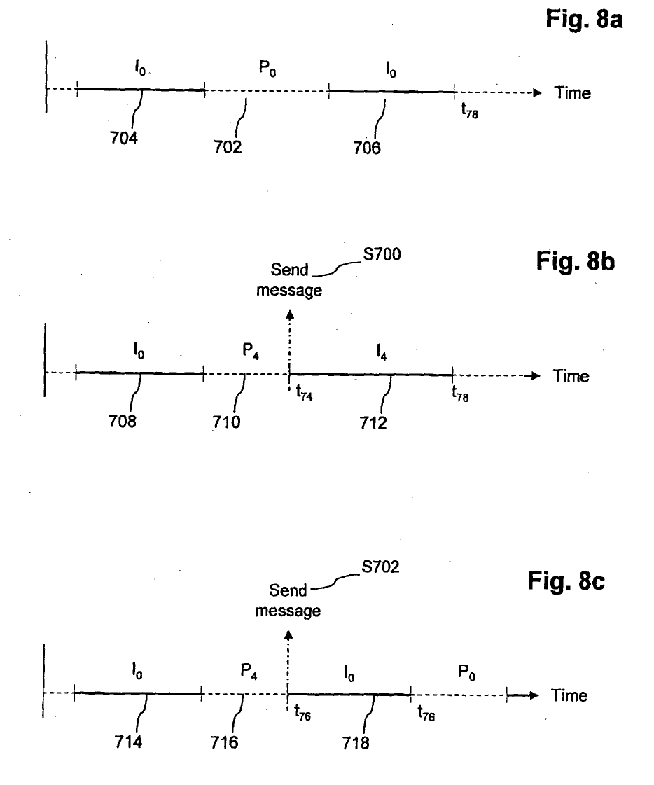

FIG. 8a shows a disconnected period, 702, of length P₀ preceded by a connected interval, 704, and succeeded by another connected interval, 706, each of length I₀. Connected interval 706 terminates at time t₇₈. No messages are sent during any of disconnected period 702, connected interval 704 or connected interval 706. FIG. 8b shows a similar sequence in which a message is sent during the disconnected period 708 at time t₇₄. The disconnected period 710 is immediately terminated at time t₇₄, and an unscheduled connection is established to allow the message to be sent. This connection is maintained until time t₇₈ and can be used, for example, to receive messages or send further messages. In effect, disconnected period 710 is reduced in length to P₄ and the succeeding connected interval, 712, is increased in length to I₄ in compensation. This means that the timing of connections and terminations subsequent to t₇₈ is unaffected.

In an alternative arrangement, shown by FIG. 8c, a message is sent at time t₇₆. As above, this precipitates the immediate establishment of a connection, the connection being maintained after the message has been sent. However, in this arrangement, although disconnected period 716 is reduced in length to P₄, the succeeding connected interval, 718 is not increased in compensation; instead connected interval 718 has length I₀. In this arrangement, the schedule of connections and terminations subsequent to the sending of the message is altered.

In alternative embodiments of the present invention, a mobile communications terminal intermittently establishes connections to a server, and determines whether any new messages are present at the server. The mobile communications terminal has a power source such as a battery, and the terminal is adapted to alter a timing characteristic of the connections in order to reduce power usage of the electric power source. The timing characteristic might be the length of time during which the connections are maintained or the frequency of the connection, for example.

The alteration of the timing characteristic is based on parameters as described above in relation to another embodiment, such as a power level of the power source, the selection of a state of operation of the terminal by the user, the time of day, the day of the week, whether the terminal is operating in a home network or a roaming network and user behaviour.

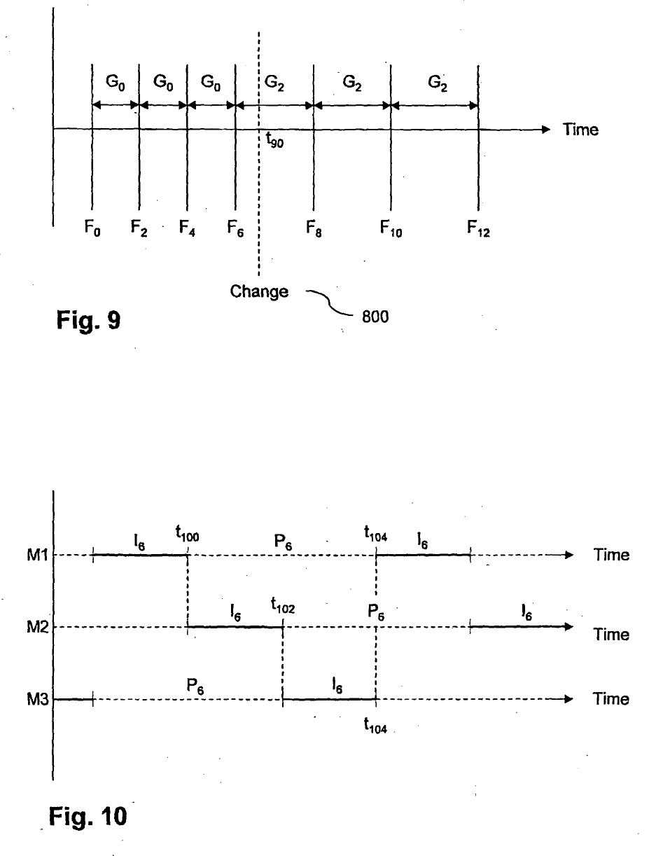

FIG. 9 shows the action of an example arrangement. In this example, the terminal is adapted to poll the server intermittently at steps F₀ . . . F₁₂. A change, 800, in one of the parameters, such as change in the time of day to a low-activity time when few messages are received, takes place at time t₉₀. Until t₉₀, the time gap between polls is G₀, but due to change 800, the gap is increased to G₂. Increasing the gap between polls reduces the rate of power consumption of the terminal.

In some embodiments, several mobile communications terminals are adapted to perform the functions described above, and used in a system with a common network 102, as represented in FIG. 1. In such systems, it can place a large burden on the resources of the network if a large number of terminals are connected to the network at the same time.

A way of avoiding this is now explained with reference to FIG. 10, which is a schematic timing diagram for three mobile communications terminals M1, M2 and M3. Each of the terminals intermittently establishes and maintains connections for connected intervals of length I₆ interspersed with disconnected periods of length P₆ during which connections are not maintained. In this arrangement the connected intervals are staggered so as not to coincide with one another. For one connected interval that completes at time t₁₀₀, only terminal M1 maintains a connection. Between t₁₀₂ and t₁₀₄, only terminal M2 maintains a connection. Between t₁₀₂ and t₁₀₄, only terminal M3 maintains a connection. From time t₁₀₄, the above sequence repeats. In this way, only one terminal of the example terminals maintains a connection at any one time, thereby reducing burden on the network.

In the above example, intervals of one terminal do not even partially coincide with intervals of another. However, particularly in systems comprising a large number of terminals, this becomes impractical; accordingly, arrangements in which intervals or respective terminals partially overlap can be used. Additionally, or alternatively, terminals may be arranged in groups, the intervals of respective groups being arranged so that they tend not to coincide. The grouping can be based on an internal feature of the terminals, such as the least significant digit of a time reading on an internal clock.

Further, in order to maintain the staggered effect of the intervals in respective terminals, schedules of connections and terminations may be determined for each terminal. Non-scheduled connections, such as those described with reference to FIG. 8a, FIG. 8b and FIG. 8c may disrupt the schedules. However, methods such as that described with reference to FIG. 8b may be employed to return to the determined schedule, avoiding permanent disruption to the schedule.

The above embodiments are to be understood as illustrative examples of the invention. Further embodiments of the invention are envisaged. For example, the network need not be a GSM network; the invention applies to any network comprising at least one mobile communications terminal and a server. Also, it is not necessary that communication takes place wirelessly or that the standard used is GPRS or that the protocol is TCP. Any method that allows transmission of messages from a server to a mobile terminal falls within the scope of the invention.

Further, above we described a procedure using IMAP according to particular steps. In other embodiments of the present invention, the details of the steps involved may differ. For example, in some applications, the initial polling may be omitted, and the idle command may be issued immediately after the connection is established. In still other embodiments, IMAP is not used, and other protocols such as, for example, POP3 are used instead.

Further, in the above, we have described methods in which the mobile terminal establishes and maintains connections directly with the server. In other embodiments, the intermittently established connections may be with another part of the network, such as a network node, and polling of the server may be conducted repeatedly over each of the established connections.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of receiving messages in a data communications network using a mobile communications terminal, said network comprising a server, said server being capable of receiving new messages, and in response to receiving said new messages, of making data relating to said new messages available for transmission to an associated mobile communications terminal,
said method comprising performing functions which said mobile communications terminal is adapted to perform, the performance of said functions comprising:
performing message receiving procedures, wherein during a message receiving procedure said mobile communications terminal is capable of receiving data relating to new messages for said mobile communications terminal received by said server since a previous message receiving procedure;
intermittently establishing connections in the network such that the terminal establishes a series of connections;
maintaining said connections for extended time intervals, wherein the mobile communications terminal is capable of performing a first said message receiving procedure over a connection after establishment of the connection and wherein the connection is extended beyond said first message receiving procedure such that, if the server receives a new message for said mobile communications terminal after said first message receiving procedure and during said extended time interval, the mobile communications terminal is capable of receiving said new message over said connection; and
terminating said connections in response to said extended time intervals elapsing, such that said series of connections are interspersed with periods during which said connections are not maintained.

2. (canceled)

3. A method according to claim 1, wherein the connections comprise connections arranged such that said mobile communications terminal is notified by the server in response to a new message arriving at the server.

4. (canceled)

5. A method according to claim 1, wherein the performance of said functions comprises conducting and/or issuing a plurality of polls to said server during said connection.

6-7. (canceled)

8. A method according to claim 1, wherein the performance of said functions comprises altering a time characteristic of at least one of said extended time intervals and said periods.

9-11. (canceled)

12. A method according to any of claim 4, wherein said mobile communications terminal comprises an electric power source, and said altering is conducted responsive to a power level of the power source.

13. A method according to claim 12, wherein the performance of said functions comprises:
monitoring a power level of said power source;
operating in a low-power mode if said power level is below a predefined level; and
operating in a high-power mode if said power level is above a predefined level;
and wherein said altering comprises altering said time characteristic according to whether the mobile communications device is operating in said low-power mode or in said high-power mode.

14. A method according to claim 8, wherein said mobile communications terminal is adapted to operate in a plurality of user-selectable states, and said altering comprises altering said time characteristic according to the state selected.

15. A method according to claim 8, wherein said altering comprises altering said time characteristic according to any or any combination of, the time of day, and/or the day of the week.

16. (canceled)

17. A method according to claim 8, wherein said mobile communications terminal is adapted to:
operate in a home mode when said network comprises a home network; and
operate in a roaming mode when said network comprises a roaming network, and
wherein said altering comprises altering said time characteristic according to whether the mobile communications terminal is operating in said roaming mode or in said home mode.

18. A method according to claim 8, comprising storing user behaviour data, wherein said altering comprises altering said time characteristic according to said user behaviour data.

19. A method according to claim 1, wherein the performance of said functions comprises establishing an unscheduled connection to the server in response to a user action, said establishing an unscheduled connection occurring during a given said period.

20. A method according to claim 19, wherein the performance of said functions comprises maintaining said unscheduled connection for a said extended time interval.

21. A method according to claim 19, wherein said user action comprises initiating the sending of a message.

22. A method of receiving messages in a data communications network using a mobile communications terminal, said mobile communications terminal comprising an electric power source, said network comprising a server, and said method comprising performing functions which said mobile communications terminal is adapted to perform, the performance of said functions comprising:
intermittently establishing connections to the server;
determining if any new messages are present at the server; and
altering a time characteristic of said intermittently established connections in order to reduce power usage for said electric power source.

23. A method according to claim 22, wherein said altering comprises altering a length of time during which said connections are maintained.

24. (canceled)

25. A method according to claim 24, wherein the performance of said functions comprises:
monitoring a power level of said electric power source;
operating in a low-power mode if said power level is below a predefined level; and
operating in a high-power mode if said power level is above said predefined level, and
wherein said altering comprises altering the time characteristic according to whether the mobile communications terminal is operating in a low-power mode or operating in a high-power mode.

26. A method according to claim 22, wherein the performance of said functions comprises operating in any of a plurality of user-selectable states, and said altering comprises altering the time characteristic according to the state selected.

27-30. (canceled)

31. A computer program arranged to adapt a mobile communications terminal to conduct the method steps of any of the preceding claims.

32. A mobile communications terminal adapted to conduct the method steps of claim 1.

33. A system comprising means to implement a method as claimed in claim 1, said system comprising a mobile communications network and plurality of mobile communications terminals, each said terminal being adapted to perform functions as recited in any previous claim.

34. A system according to claim 32, wherein said mobile communications terminals are arranged such that said connections of a given said terminal tend not to coincide with respective connections on another said terminal.

35. A system according to claim 34, wherein the plurality of mobile communications terminals are grouped so that said extended time intervals of a given group tend not to coincide with said extended time intervals of another group.

36. A system according to claim 33, wherein said terminals comprise scheduling means for scheduling timings of said extended time intervals according to schedules triggered by internal clocks on the terminals.

37. A system according to claim 36, wherein said terminals comprise connecting means for performing unscheduled connections, and wherein said scheduling means are capable of controlling subsequent connections such that schedules are returned to after the occurrence of an unscheduled connection.

38. A method of receiving messages in a data communications network using a mobile communications terminal, said network comprising a server capable of receiving new messages, and in response to receiving said new messages, of making data relating to said new messages available for transmission to an associated mobile communications terminal, said method comprising controlling the connection between the server and the mobile communication terminal to specific time intervals during which messages can be received by the terminal from the server and wherein the duration of said specific time intervals and the frequency of connection is controlled via the mobile communications terminal in response to a user selected operating mode of the terminal and/or at least one parameter of the operating condition of the mobile communications terminal at that time.

39. A method according to claim 38 wherein the user selected operating mode is selected by the user in response to a particular environment in which the terminal is positioned.

40. (canceled)

41. A method according to claim 38 wherein if a predetermined number of messages are received within a specific connection time period the terminal extends the duration of the specific connection time period.

42. A method according to claim 38 wherein if a message is received at, or near the end of, a specific connection time period the terminal extends the duration of the specific connection time period.
